(19) United States
(12) Patent Application Publication
(10) Pub. No.: US 2008/0094297 A1
(43) Pub. Date: Apr. 24, 2008

(54) WIDEBAND FRACTAL SLOT ANTENNA

(76) Inventors: Peter Petkov, Sofia (BG); George Stantchev, Phoenix, AZ (US)

Correspondence Address: GEORGE STANTCHEV, 15831 N. 33RD PL., PHOENIX, AZ, 85032, US

(21) Appl. No.: 11/552,056

(22) Filed: Oct. 23, 2006

(51) Int. Cl. H01Q 13/10

(52) U.S. Cl. 343/767

(57) ABSTRACT

A fractal slot antenna developed for wideband communications with a reflector that increases the gain and preserves the wideband capability of the antenna. This is a typical microstrip slot antenna that is consisted from microstrip feed and radiating slot made in conductive ground. The slot shape is modified in meanings of fractal geometry. The antenna main advantage is the relatively large bandwidth and moderate efficiency. In a typical microstrip antenna the presence of reflector decreases the antenna bandwidth. Authors of this patent has discovered that applying fractalization rules in several orders to the radiating slot of the microstrip slot antennas improves their properties and particularly gain, efficiency and bandwidth in the presence of reflector. This rule will help the creation of so called “ultra wide band” antennas—with operational bandwidth more than 1-10 GHz. This antenna implementation is a recommended for WiMax, WiFi, Ultra Wideband (UWB), cell phone, GPS, DAB and various automotive implementations that need well integrated, wide bandwidth and high gain antennas.

The invented antenna is a fractal slot antenna developed for wideband communications with a reflector that increases the gain and preserves the wideband capability of the antenna.

Fractal slot microstrip antennas are slot antennas in which the radiating slot is fractalized in conductive ground plane in means of fractal (Mandelbrot) geometry. The term fractal means broken or irregular fragments were chosen from Mandelbrot to describe complex shapes that possess an inherent self similarity.

The reflector mounted behind the fractal plane improves the gain of the antenna without to affect its wideband characteristics compared to plane slot antenna where the gain is a trade off with the frequency bandwidth.

The fractalization of the radiating slot in the conductive plane leads to three significant improvements: increase antenna efficiency, increase antenna bandwidth and increase gain while maintaining wide bandwidth compared to the non fractalized antennas.

This particular microstrip slot antenna consists of a microstrip feed and radiating slot made in conductive ground. The antenna main advantage is the relatively large bandwidth and moderate efficiency. In typical microstrip antenna realizations the presence of reflector decreases the antenna bandwidth.

The fractal geometry of the invented antenna is based on self-similar fragmented geometry in conjunction with radiating slot located in the planar layer of the antenna and reflector located on calculated distance from the antenna plain.

Authors of this patent has discovered that applying fractalization rules in several orders to the radiating slot of the microstrip slot antennas improves their properties—efficiency and bandwidth in presence of reflector. This rule allows the current invention to be implemented in “ultra wide band” antennas. These antennas have the typical operational bandwidth of 1-10 GHz.

This invention provides a method of creating ultra wideband high gain fractal antennas. The method is based on applying of fractalization rules (regular or irregular shapes) on known microstrip and (or) slotted radiators. Fractalization term was first used from Benoit Mandelbrot. Until now several regular shapes are known—Koch Island, Sierpinski gasket, Cantor Set, Minkovski island etc. and several irregular as Fractal tree, Fractal Snowflake, Koch curve, Minkovsky curve, etc.

The prior art planar antenna with aperture (2) is cut in conductive layer (1) and has feed (3) is shown at FIG. 1.

All the antennas shown are scaled to 87 mm×72 mm cooper cut using 1.6 mm FR4 substrate material.

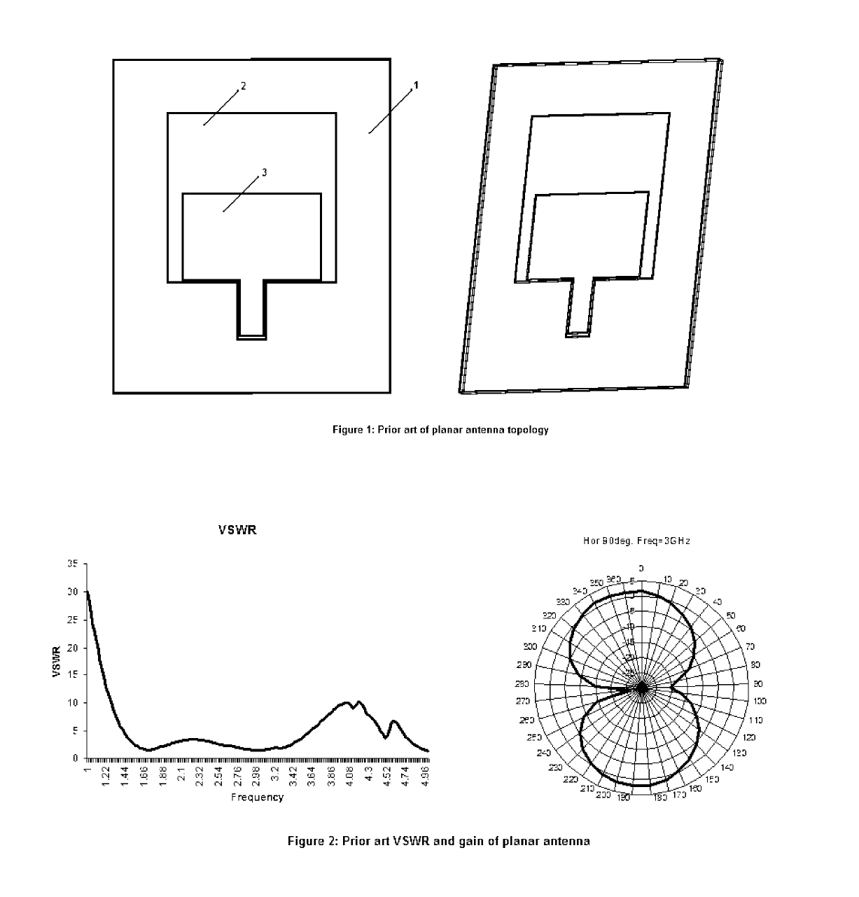

FIG. 2 shows VSWR and gain of prior art planar antenna without reflector with layout similar to the layout given at FIG. 1.

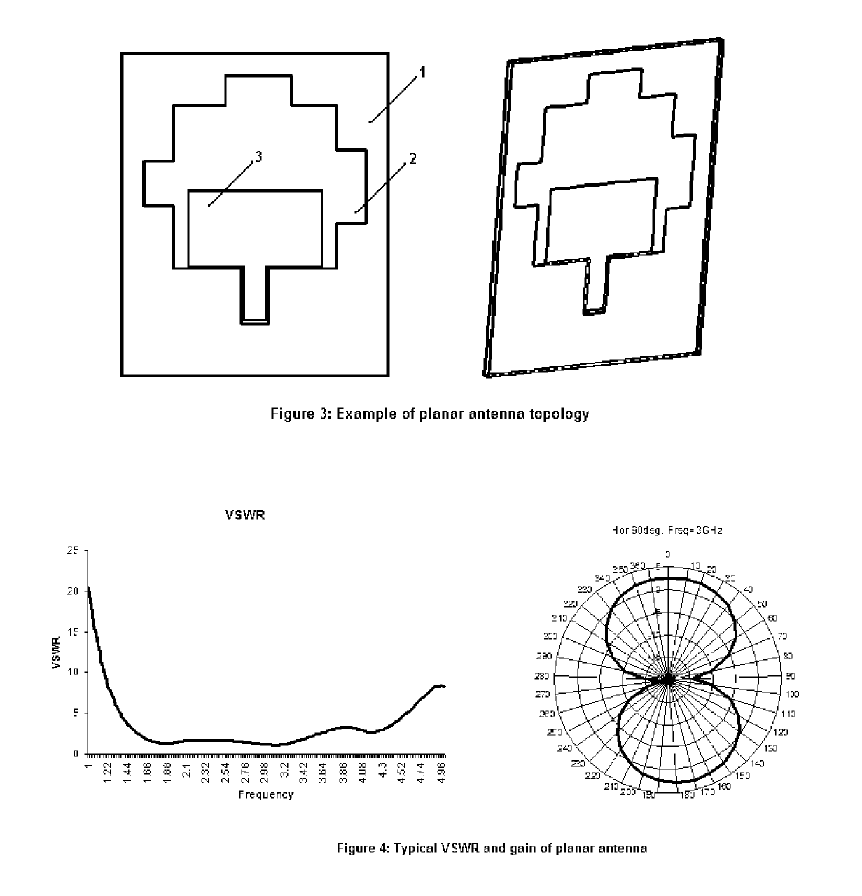

The current invention is an apparatus including the fractal aperture, feed and reflector for improving the gain. The feed (3) is located in a planar layer with the aperture (2) cut in a conductive layer (1) regarding FIG. 3. The feed also can be in a layer above or below the aperture.

FIG. 4 shows VSWR and gain of antenna without reflector with layout similar to the layout given at FIG. 3.

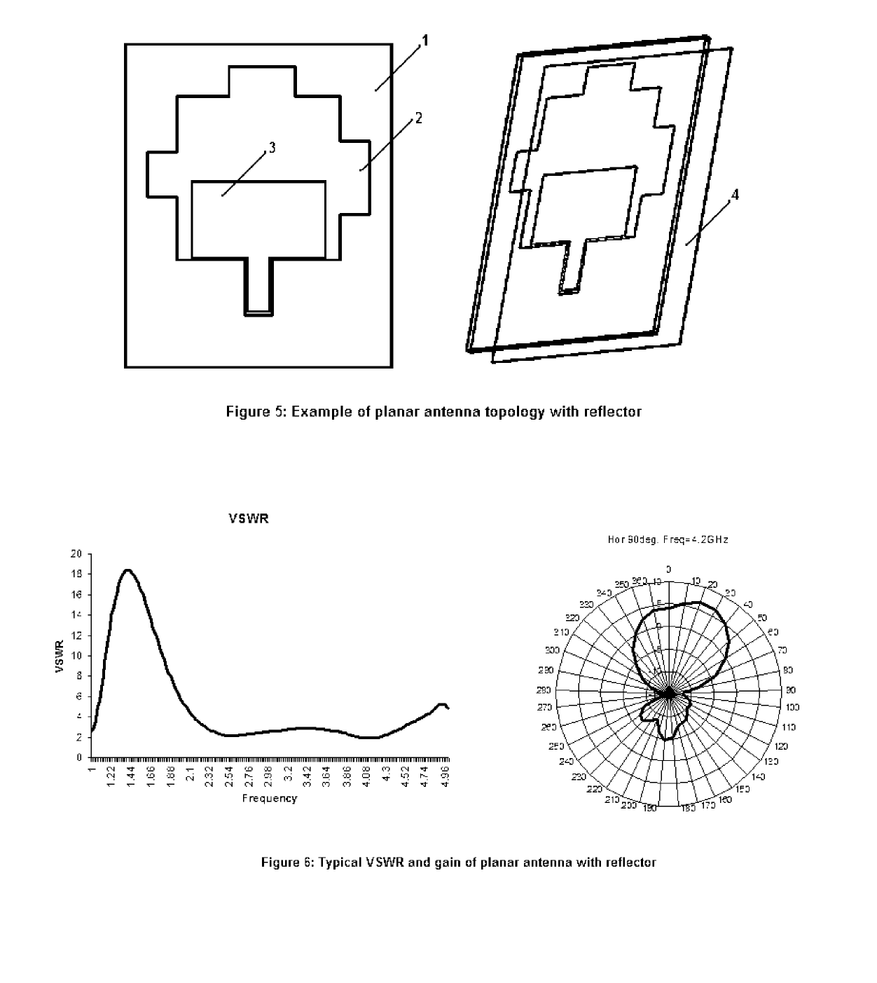

FIG. 5 shows reflector (4) added under the antenna plane located on calculated distance from the feed that improves the overall gain of the antenna.

On FIG. 6 is given VSWR and gain of antenna with reflector and layout according FIG. 5.

What is claimed is:

1. Fractal slot antenna comprising a fractal aperture and a feed.

2. Fractal slot antenna regarding claim 1 where the feed is located in a planar layer with the antenna.

3. Fractal slot antenna using microstrip technology layout on a properly chosen substrate regarding claim 1 where the feed is located in a planar layer with the antenna.

4. Fractal slot antenna regarding claim 1 where the feed is located on a different layer than the antenna.

5. Fractal slot antenna using microstrip technology layout on a properly chosen substrate regarding claim 1 where the feed is located on a different layer than the antenna.

6. Fractal slot antenna regarding claim 1 with a planar feed and reflector located at computational distance from the fractal antenna.

7. Fractal slot antenna using microstrip technology layout on a properly chosen substrate regarding claim 1 with a planar feed and reflector located at computational distance from the fractal antenna.

8. Fractal slot antenna regarding claim 1 with a feed in a different layer than the antenna and reflector located at computational distance from the fractal antenna.

9. Fractal slot antenna using microstrip technology layout on a properly chosen substrate regarding claim 1 with a feed in a different layer than the antenna and reflector located at computational distance from the fractal antenna.

10. Fractal antenna regarding claim 1 where the reflector is calculated to reflect energy in phase with the radiated electromagnetic field.

11. Fractal antenna using microstrip technology layout on a properly chosen substrate regarding claim 1 where the reflector is calculated to reflect energy in phase with the radiated electromagnetic field.
